(19) United States
(12) Patent Application Publication
(10) Pub. No.: US 2017/0168852 A1
(43) Pub. Date: Jun. 15, 2017

(54) METHOD FOR INITIALIZING PERIPHERAL DEVICES AND ELECTRONIC DEVICE USING THE SAME

(71) Applicant: Industrial Technology Research Institute, Hsinchu County (TW)

(72) Inventors: Tzu-Chieh SHEN, Hsinchu (TW); Kuo-Hung LIN, Hsinchu (TW); Shi-Wu LO, Hsinchu (TW)

(21) Appl. No.: 15/093,546

(22) Filed: Apr. 7, 2016

(30) Foreign Application Priority Data
Dec. 14, 2015 (TW) 104141902

(51) Int. Cl. G06F 9/44

(52) U.S. Cl. CPC G06F 9/4411; G06F 9/4418

(57) ABSTRACT

A method for initializing a peripheral device and an electronic device using the method. The electronic device includes one or more peripheral devices having registers, a memory having a data storing module, and an instruction capturing module. The instruction capturing module captures a plurality of hardware register settings from a driver execution process of the one or more peripheral devices, stores the plurality of hardware register settings in the data storing module, and serializes or concatenates the plurality of hardware register settings to form serialized hardware register settings, when the electronic device is performing a non-hibernation resume or non-wakeup cold boot to execute an initialization process of the one or more peripheral devices. The one or more peripheral devices are initialized by the serialized hardware register settings, when the electronic device is performing cold boot again due to a hibernation resume or wakeup to execute the initialization process.

### CROSS-REFERENCE TO RELATED APPLICATION

The present application is based on, and claims priority from Taiwan Patent Application Number 104141902, filed Dec. 14, 2015, the disclosure of which is hereby incorporated by reference herein in its entirety.

### TECHNICAL FIELD

This disclosure relates to fast booting techniques, and, more particularly, to a method for initializing a peripheral device and an electronic device using the same.

### BACKGROUND

A fast booting function installed in an electronic device, such as a smart phone, a smart appliance, a wearable device or an Internet of Things device makes digital information to be captured conveniently. The electronic device, when closing down, operates in a standby mode, rather than in a real shut-down mode. Although the standby mode reduces the booting time of the electronic device effectively, the electronic device still keeps consuming power and operating in a high power consumption state, which generates a great amount of carbon dioxide.

Currently, an electronic device has the power saving mechanism such as a hibernation or wakeup boot function where the device operates in a real shut down mode or hibernation mode to reduce power consumption. When booting, the electronic device is cold booting by a hibernation booting technique, as shown in FIGS. 1 and 2.

FIG. 1 is a flow chart illustrating shutting-down an electronic device having a hibernation or wakeup booting function according to the art. In step S01, a freeze process is performed before the electronic device is hibernated. In step S02, a first snapshot image corresponding to application programs in the electronic device is created. In step S03, one or more peripheral devices of the electronic device are suspended.

In step S04, a second snapshot image corresponding to a kernel of an operating system in the electronic device is created. In step S05, the first snapshot image and the second snapshot image are written into a permanent storage device of the electronic device. In step S06, the electronic device is powered off.

FIG. 2 is a flow chart illustrating cold booting an electronic device having a hibernation or wakeup booting function according to the art. In step S11, the electronic device is performing a cold booting. In step S12, an initialization loader program (boot-loader) of the electronic device is executed (about 1 second). In step S13, the kernel and the one or more peripheral devices are initializing (about 2.8 seconds), in which a plurality of software settings (in a memory) of the one or more peripheral devices are executed in step S131, and a plurality of hardware register settings (in the peripheral devices) are executed in step S132.

In step S14, a second snapshot image is loaded from the permanent storage device (about 0.8 second), in which the software settings of the one or more peripheral devices before the hibernation are resumed in step S141. In step S15, the one or more peripheral devices are resumed (about 2.4 seconds), in which the plurality of hardware register settings of the one or more peripheral devices before the hibernation are resumed in step S151. In step S16, the first snapshot image is loaded from the permanent storage device (about 3.0 seconds), and in step S17, a thaw process (e.g., wakeup process) of the electronic device is performed.

In the cold booting process of the electronic device of FIG. 2, which lasts about 10 seconds, the initialization of the kernel and the one or more peripheral devices in step S13 takes 2.8 seconds, and the resuming of the one or more peripheral devices in step S15 takes 2.4 second, which are a total of 5.2 seconds. When the one or more peripheral devices are initialed in step S13, the plurality of software settings in step S131 and the plurality of hardware register settings in step S132 have to be executed at the same time, which may prolong the initialization time and resuming time of the one or more peripheral devices, such that the booting time of the electronic device is slow.

Therefore, how to solve the problems of the above mentioned art is becoming an urgent issue.

### SUMMARY

In an embodiment according to the present disclosure, a method for initializing a peripheral device and an electronic device using the same are provided, which simplify an initialization process of the peripheral device and reduce the booting time of the electronic device.

In an embodiment according to the present disclosure, an electronic device having a hibernation or wakeup booting function comprises: one or more peripheral devices each having one or more registers; a memory having a data storing module; and an instruction capturing module. The instruction capturing module is configured to capture a plurality of hardware register settings from a driver execution process of the one or more peripheral devices, store the plurality of hardware register settings in the data storing module, and serialize or concatenate the plurality of hardware register settings in the data storing module to form serialized hardware register settings, when the electronic device is performing a non-hibernation resume or non-wakeup cold boot to execute an initialization process of the one or more peripheral devices, wherein the one or more peripheral devices are configured to be initialized by the serialized hardware register settings, when the electronic device is performing cold boot again due to a hibernation resume or wakeup to execute the initialization process of the one or more peripheral devices.

In an embodiment according to the present disclosure, a method for initializing a peripheral device comprises: providing an electronic device having a hibernation or wakeup booting function, wherein the electronic device comprises one or more peripheral devices and a memory, the one or more peripheral devices each have one or more registers, and the memory has a data storing module. The method further includes: capturing a plurality of hardware register settings from a driver execution process of the one or more peripheral devices; storing the plurality of hardware register settings in the data storing module; serializing or concatenating the plurality of hardware register settings in the data storing module to form serialized hardware register settings, when the electronic device is performing a non-hibernation resume or non-wakeup cold boot to execute an initialization process of the one or more peripheral devices; and initializing the one or more peripheral devices by the serialized hardware register settings, when the electronic device is performing cold boot again due to a hibernation resume or wakeup to execute the initialization process of the one or more peripheral devices.

### BRIEF DESCRIPTION OF DRAWINGS

The disclosure can be more fully understood by reading the following detailed description of the preferred embodiments, with reference made to the accompanying drawings, wherein:

FIG. 1 is a flow chart illustrating shutting-down an electronic device having a hibernation or wakeup booting function according to the art;

FIG. 2 is a flow chart illustrating cold booting an electronic device having a hibernation or wakeup booting function according to the art;

FIG. 3 is a functional block diagram of an electronic device having a hibernation or wakeup booting function of an embodiment according to the present disclosure;

FIG. 4 is a flow chart illustrating cold booting an electronic device having a hibernation or wakeup booting function of an embodiment according to the present disclosure;

FIG. 5 is a schematic diagram illustrating an initialization process of one or more peripheral devices of an embodiment according to the present disclosure;

FIG. 6 is a schematic diagram illustrating forming a driving program of one or more peripheral devices into serialized hardware register settings (serialized hardware instructions) of an embodiment according to the present disclosure;

FIG. 7 is a schematic diagram illustrating forming a driving program of one or more peripheral devices into serialized hardware register settings (serialized hardware instructions) of another embodiment according to the present disclosure;

FIG. 8 is a schematic diagram illustrating an optimization algorithm used to optimize serialized hardware instructions (serialized hardware register settings) to form optimized and serialized hardware instructions (optimized and serialized hardware register settings) of an embodiment according to the present disclosure;

FIG. 9A is a schematic diagram illustrating a data structure (e.g., a tree structure) and one or more nodes thereof that represent one or more peripheral devices of an embodiment according to the present disclosure;

FIG. 9B is a schematic diagram illustrating a driver execution process of one or more peripheral devices of an embodiment according to the present disclosure;

FIG. 10 is a schematic diagram illustrating program codes of a data structure of an embodiment according to the present disclosure;

FIG. 11 is a schematic diagram illustrating monitoring a register of a peripheral device through a page fault processing mechanism to capture hardware register settings (hardware instructions) of an embodiment according to the present disclosure;

FIG. 12A is a flow chart illustrating that an electronic device having a hibernation or wakeup booting function is performing a non-hibernation resume or non-wakeup cold boot of an embodiment according to the present disclosure;

FIG. 12B is a flow chart illustrating a method for initializing a peripheral device of an embodiment according to the present disclosure; and

FIG. 13 is a flow chart illustrating that an electronic device having a hibernation or wakeup booting function is performing cold boot again due to hibernation resume or wakeup.

### DETAILED DESCRIPTION

In the following detailed description, for purposes of explanation, numerous specific details are set forth in order to provide a thorough understanding of the disclosed exemplary embodiments. However, that one or more embodiments may be practiced without these specific details. In other instances, well-known structures and devices are schematically shown in order to simplify the drawing.

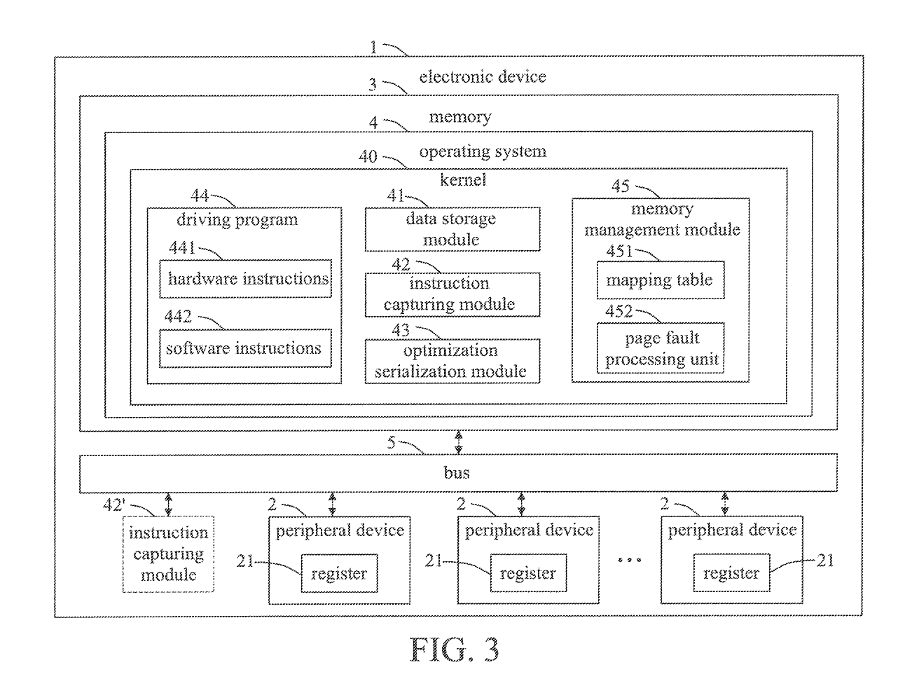

FIG. 3 is a functional block diagram of an electronic device 1 having a hibernation or wakeup booting function of an embodiment according to the present disclosure. The electronic device 1 has a hibernation or wakeup booting function, and comprises one or more peripheral devices 2 having registers 21, a memory 3 having a data storing module 41, an operating system 4 having a kernel 40, an instruction capturing module 42 (or an instruction capturing module 42′), an optimization serialization module 43, one or more driving programs 44 having hardware instructions 441 and software instructions 442, a memory management module 45 having a mapping table 451 and a page fault processing unit 452, and a bus 5.

When the electronic device 1 is performing a non-hibernation resume or non-wakeup cold boot (e.g., the first cold boot) to execute an initialization process of the one or more peripheral devices 2, the instruction capturing module 42 captures a plurality of hardware register settings (the hardware instructions 441) and corresponding information thereof (e.g., the execution time or instruction intervals of the hardware instructions) from a driver execution process (the execution process of one or more driving programs 44) of the one or more peripheral devices 2, without capturing a plurality of software settings (the software instructions 442). The instruction capturing module 42 stores a plurality of hardware register settings (the hardware instructions 441) and corresponding information thereof into the data storing module 41, and serializes or concatenates a plurality of hardware register settings (the hardware instructions 441) in the data storing module 41, so as to form serialized hardware register settings (serialized hardware instructions).

The optimization serialization module 43 optimizes an access order of the serialized hardware register settings according to an optimization algorithm to form optimized and serialized hardware register settings.

Then, when the electronic device 1 is performing cold boot (e.g., the second cold booting) due to a hibernation resume or wakeup to execute the initialization process of the one or more peripheral devices 2, the one or more peripheral devices 2 are initialized by the serialized hardware register settings (serialized hardware instructions), or the optimized and serialized hardware register settings (optimized and serialized hardware instructions).

In an embodiment, the electronic device 1 may be, but is not limited to a smart phone, a smart appliance, a wearable device, or an Internet of Things device. The memory 3 may be a volatile memory or a nonvolatile memory. The data storing module 41 may be a data structure or an array. The data structure may be a tree structure or a concatenate (LIST) structure. The array may be an instruction array, and the bus 5 may be a system bus or a sub-bus.

In an embodiment, the operating system 4 and the kernel 40 thereof are disposed in the memory 3, the data storing module 41, the instruction capturing module 42, the optimization serialization module 43 and the memory management module 45 are disposed in the kernel 40, and program codes of the data storing module 41, the instruction capturing module 42 and the optimization serialization module 43 may be centralized program codes combination at a single position or distributed program codes combination at a plurality of positions in the operating system 4.

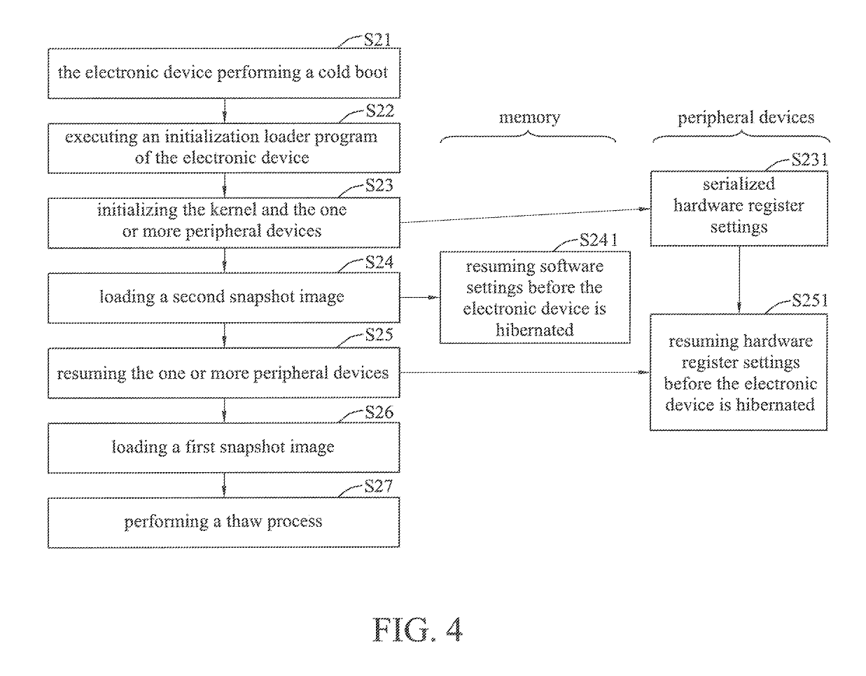

FIG. 4 is a flow chart illustrating cold booting the electronic device 1 having the hibernation or wakeup booting function of an embodiment according to the present disclosure. As shown in embodiments of FIG. 4 and FIG. 3, in step S21, the electronic device 1 is performing a cold boot. In step S22, an initialization loader program (boot-loader) of the electronic device 1 is executed. In step S23, the kernel 40 and the one or more peripheral devices 2 are initialized, in which the serialized hardware register settings (the hardware instructions 441) are executed in step S231.

Then, in step S24, a second snapshot image is loaded from a permanent storage device (not shown) of the electronic device 1, including step S241 in which software settings (the software instructions 442) of the one or more peripheral devices 2 are resumed back to a state before the electronic device 1 is hibernated. In step S25, the one or more peripheral devices 2 are resumed, including step S251 in which the plurality of hardware register settings (the hardware instructions 441) are resumed back to a state before the electronic device 1 is hibernated. In step S26, a first snapshot image is loaded from the permanent storage device. In step S27, a wakeup process of the electronic device 1 is performed.

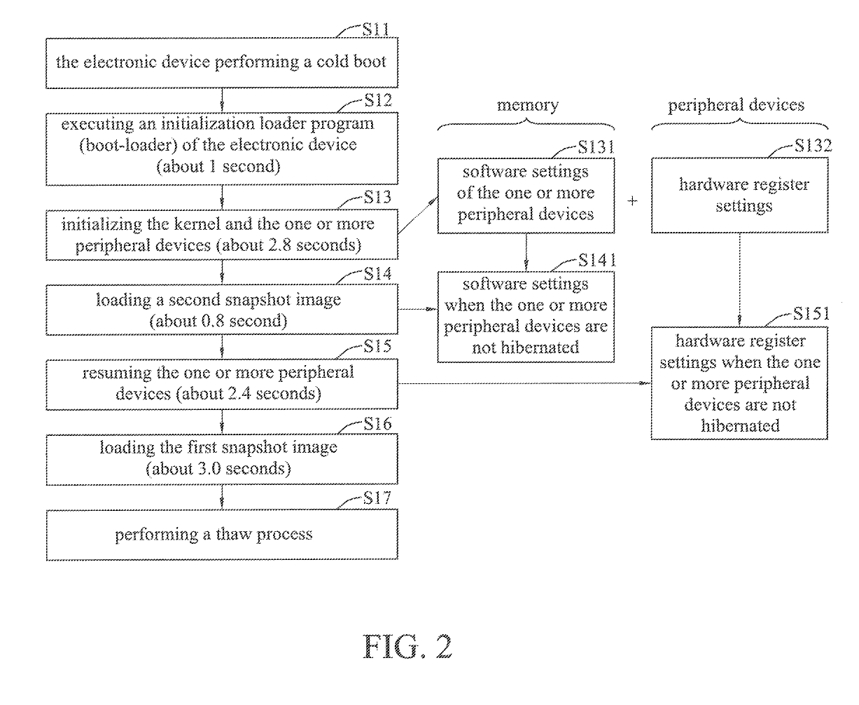

When step S13 “the one or more peripheral devices are initialized” shown in FIG. 2 according to the art is executed, “a plurality of software settings” and “a plurality of hardware register settings” have to be executed in steps S131 and S132, respectively, such that the time for initializing the one or more peripheral devices and booting the electronic device is prolonged. Nevertheless, when step S23 shown in FIG. 4 according to the present disclosure is executed, only “serialized hardware register settings (the serialized hardware instructions)” needs to be executed in step S231, such that the initialization process of the one or more peripheral devices 2 is simplified, and the time for initializing the one or more peripheral devices 2 and booting the electronic device 1 may be reduced.

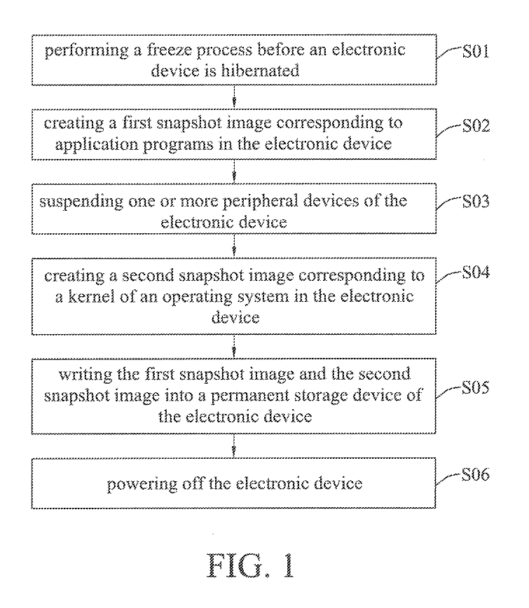

A shut-down process of the electronic device 1 of an embodiment according to the present disclosure may be the same as or similar to the shut-down process shown in FIG. 1 according to the art, further description hereby omitted.

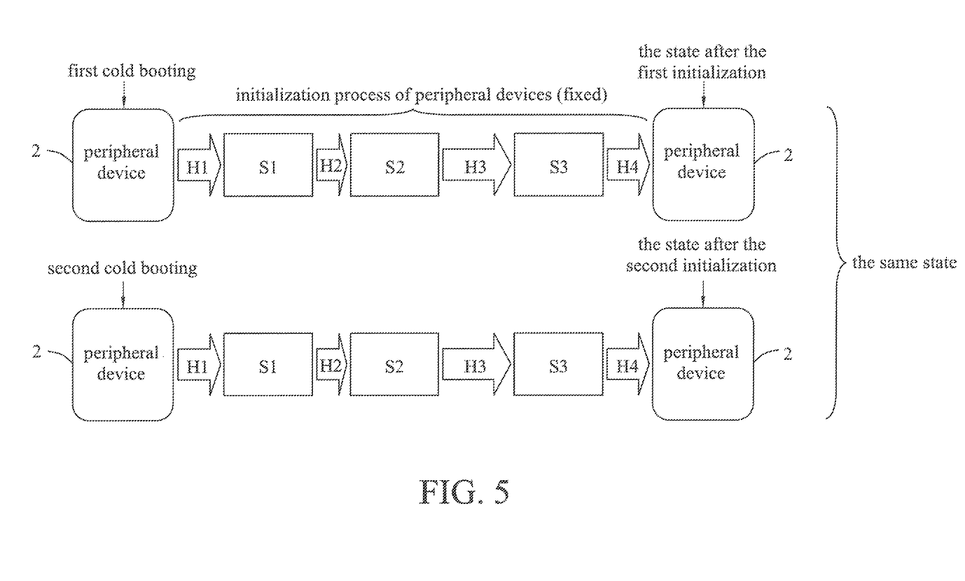

FIG. 5 is a schematic diagram illustrating an initialization process of one or more peripheral devices 2 of an embodiment according to the present disclosure. In an embodiment shown in FIG. 5 and FIG. 3, when the electronic device 1 is performing a non-hibernation resume or non-wakeup cold boot for the first time, and is performing a hibernation resume or wakeup cold boot every time since, if the initialization processes of the one or more peripheral devices 2 are the same, and it is assumed that the initialization processes are alternative execution of a plurality of hardware settings H1-H4 (hardware instructions 441) and a plurality of software settings S1-S3 (software instructions 442) of a driving program 44, the state of the one or more peripheral devices 2 after the first initialization shall be the same as the state of the one or more peripheral devices 2 after every hibernation resume or wakeup initialization, which indicates that the one or more peripheral devices 2 having the same initialization state individually, after the same initialization processes, will have the same initialization state.

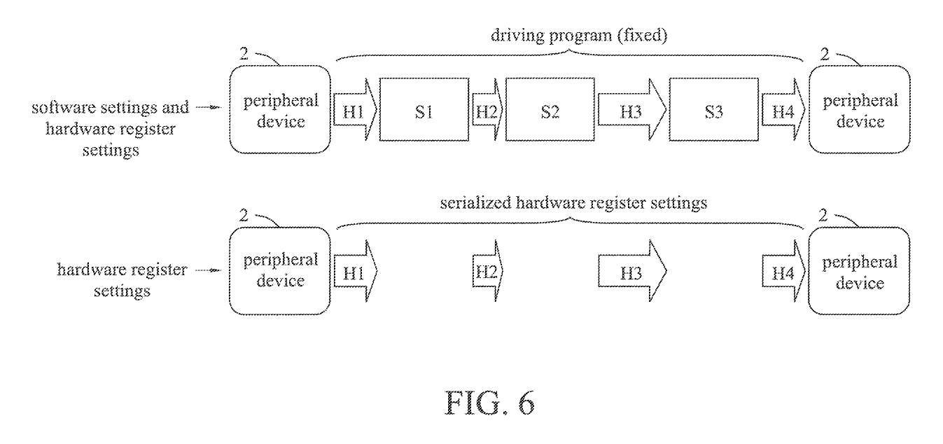

FIG. 6 is a schematic diagram illustrating forming a driving program 44 of one or more peripheral devices 2 into serialized hardware register settings (serialized hardware instructions) of an embodiment according to the present disclosure. As shown in the embodiment of FIG. 6 and FIG. 3, when the driving program 44 of the one or more peripheral devices 2 is fixed, the one or more peripheral devices 2 having the same initialization state, through the plurality of hardware register settings H (e.g., H1-H4) or the hardware instructions 441, will obtain the same state. In other words, only the plurality of hardware register settings H (e.g., H1-H4) or the hardware instructions 441 will affect the state of the one or more peripheral devices 2, and the plurality of software settings S (e.g., S1-S3) or the software instructions 442 will not affect the state of the one or more peripheral devices 2.

According to the above principle, the present disclosure could capture a plurality of hardware register settings H (e.g., H1-H4) or hardware instructions 441 from the driver execution process (execute the driving program 44) of the one or more peripheral devices 2, and serialize or concatenate the plurality of hardware register settings H (e.g., H1-H4) or the hardware instructions 441, so as to form serialized hardware register settings or serialized hardware instructions.

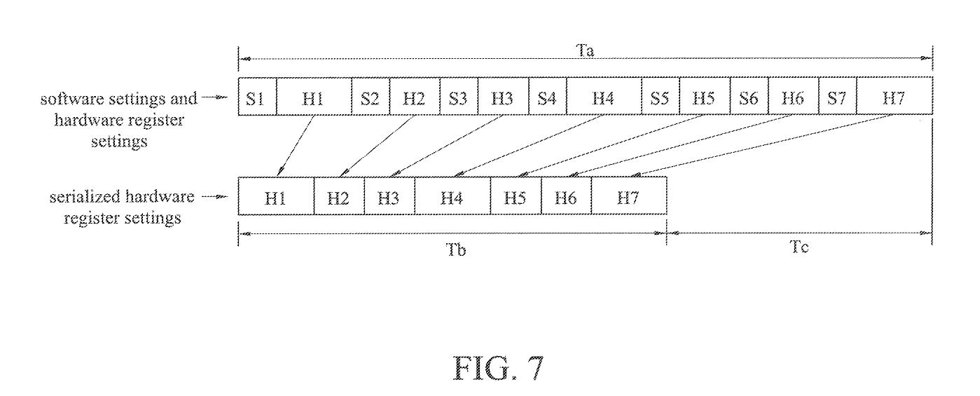

FIG. 7 is a schematic diagram illustrating forming the driving program 44 of the one or more peripheral devices 2 into serialized hardware register settings (serialized hardware instructions) of another embodiment according to the present disclosure. As shown in the embodiment of FIG. 7 and FIG. 3, if it is assumed that the original initialization processes of the one or more peripheral devices 2 are alternative execution of the plurality of software settings S1-S7 (software instructions 442) and the plurality of hardware register settings H1-H7 (hardware instructions 441) of the one or more driving programs 44, the original execution time of the driving program 44 is Ta.

In an embodiment according to the present disclosure, since the plurality of hardware register settings H1-H7 (hardware instructions 441) are captured from the driver execution process of the one or more driving programs 44, and the plurality of hardware register settings H1-H7 (hardware instructions 441) are serialized or concatenated to form serialized hardware register settings (serialized hardware instructions), the serialized execution time of the one or more driving programs 44 is Tb. Therefore, the time needed for the plurality of software settings S1-S7 of the one or more driving programs 44 is saved, so as to obtain the reduced execution time of the one or more driving programs 44, that is Tc (i.e., Ta-Tb).

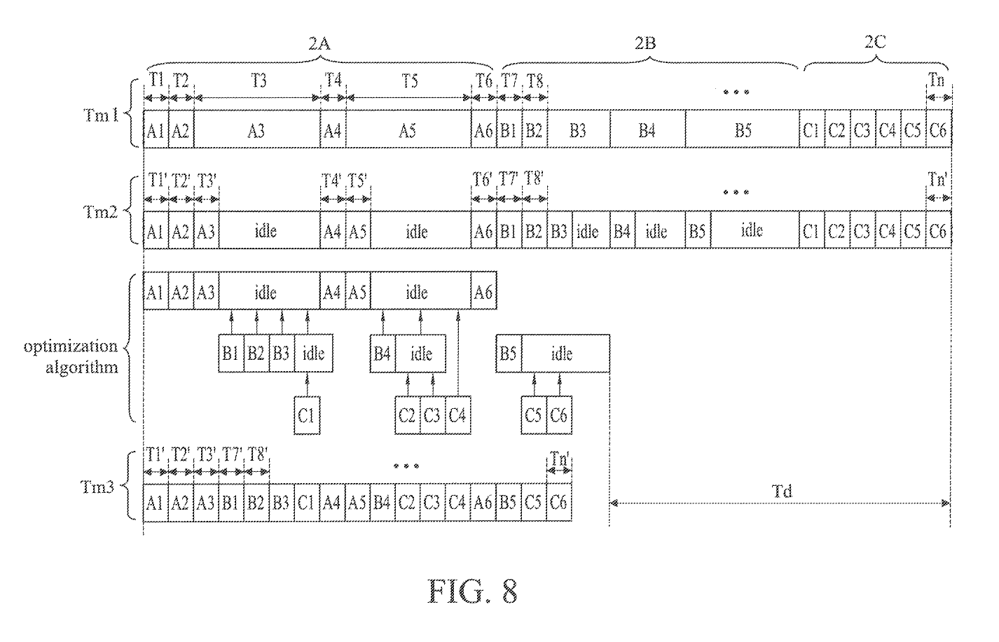

FIG. 8 is a schematic diagram illustrating optimizing serialized hardware instructions (see Tm1) or serialized hardware register settings by an optimization algorithm to form optimized and serialized hardware instructions (see Tm3) or optimized and serialized hardware register settings of an embodiment according to the present disclosure.

As shown in the embodiment of FIG. 8 and FIG. 3, it is assumed that serialized hardware instructions (see Tm1) of three peripheral devices 2A-2C are serialized or concatenated to be a plurality of hardware instructions 441 (e.g., hardware instructions A1-A6, B1-B5, C1-C6), the time distribution Tm1 of the serialized hardware instructions are execution time T1-Tn of the plurality of hardware instructions 441 (e.g., A1-A6, B1-B5, C1-C6), time distribution Tm2 of the serialized hardware instructions (see Tm2) in a bus 5 are instruction-sending time T1′-Tn′ of the plurality of hardware instructions 441, and the plurality of hardware instructions 441 (e.g., A3, A5, B3, B4, B5) in the bus 5 have one or more idle time “idle” (see Tm2). In an embodiment, the one or more idle time “idle” is waiting time of the one or more hardware instructions 441 (e.g., A3, A5, B3, B4, B5) in the bus 5, or a portion that exceeds instruction-sending time of the one or more hardware instruction 441.

In an embodiment, an optimization algorithm of the optimization serialization module 43 is used to optimize the serialized hardware instructions (see Tm1) or serialize an access order of the hardware register settings, so as to form optimized and serialized hardware instructions (see Tm3) or optimized and serialized hardware register settings. In an embodiment, the optimization algorithm of the optimization serialization module 43 inserts a plurality of hardware instructions 441 (e.g., B1-B4, C1-C6) into one or more idle time “idle” (see Tm2) sequentially, so as to form optimized and serialized hardware instructions (see Tm3) or optimized and serialized hardware register settings. When the electronic device 1 is performing a cold boot again (e.g., the second cold boot) to execute the initialization process of the one or more peripheral devices 2, the one or more peripheral devices 2 can be initialized by the optimized and serialized hardware instructions (see Tm3) or the optimized and serialized hardware register settings.

In an embodiment, the optimization algorithm serializes or concatenates, through the bus 5, the serialized hardware instructions (e.g., A1-A6, B1-B5, C1-C6 in the time distribution Tm1) into the optimized and serialized hardware instructions (e.g., A1, A2, A3, B1, . . . , C6 in the time distribution Tm3), the time distribution Tm3 of the optimized and serialized hardware instructions is a plurality of instruction-sending time (e.g., T1′, T2′, T3′, T7′, Tn′), and the plurality of instruction-sending time T1′-Tn′ may be the same or different from one another. Therefore, the reduced execution time of the bus 5 is Td.

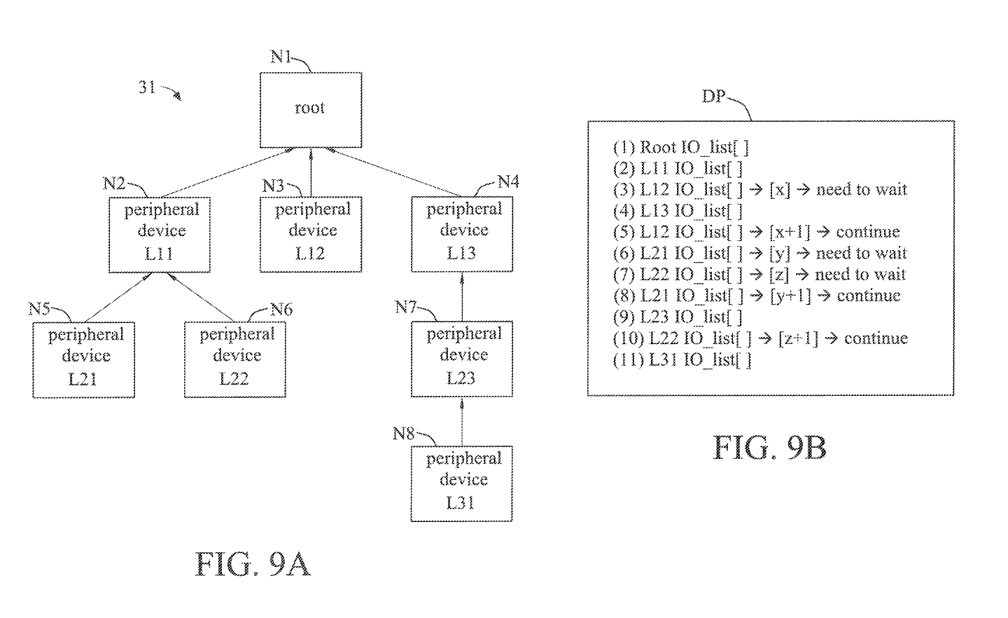

FIG. 9A is a schematic diagram illustrating a data structure 31 (e.g., a tree structure, but is not limited thereto) and one or more nodes N (e.g., N2-N8) thereof that represent one or more peripheral devices 2 (e.g., L11-L13, L21-L23, L31) of an embodiment according to the present disclosure. FIG. 9B is a schematic diagram illustrating a driver execution process of one or more peripheral devices 2 (e.g., L11-L13, L21-L23, L31) of an embodiment according to the present disclosure.

As shown in the embodiment of FIG. 9A and FIG. 3, the data storing module 41 is a data structure 31 such as a tree structure and has one or more nodes N (e.g., N1-N8), and the one or more nodes N (e.g., N2-N8) each have one or more buffers (not shown) to store a plurality of hardware register settings (hardware instructions 441) and execution time thereof.

One or more nodes N (e.g., N2-N8) represent one or more peripheral devices 2 (e.g., L11-L13, L21-L23, L31), respectively, and a relation of the nodes N (e.g., N2-N8) represents dependency of a plurality of peripheral devices 2 (e.g., L11-L13, L21-L23, L31), when there are a plurality of peripheral devices. In an embodiment, nodes N2-N4 are disposed at the same layer (e.g., brotherhood relation), which indicates that the peripheral device L11-L13 are independent, without dependency. In another embodiment, nodes N2 and N5 are disposed at an upper layer and a lower layer, respectively, which indicates that the peripheral devices L11 and L21 are not independent, with dependency existing therebetween instead.

As shown in the embodiment of FIG. 9B and FIG. 3, the driver execution process DP of a plurality of peripheral devices 2 (e.g., L11-L13, L21-L23, L31) can be further constituted according to the relation of the plurality of nodes N (e.g., N2-N8) shown in FIG. 9A, that is whether the peripheral devices 2 (e.g., L11-L13, L21-L23, L31) are independent (without dependency) or not (with dependency).

In an embodiment, the driver execution process DP of the plurality of peripheral device 2 executes the nodes in the following order: (1) node N1 (root node), (2) a peripheral device L11 of node N2 (child node), (3) a peripheral device L12 of node N3, (4) a peripheral device L13 of node N4, (5) a peripheral device L12 of node N3, (6) a peripheral device L21 of node N5, (7) a peripheral device L22 of node N6, (8) a peripheral device L21 of node N5, (9) a peripheral device L23 of node N7, (10) a peripheral device L22 of node N6, and (11) a peripheral device L31 of node N8.

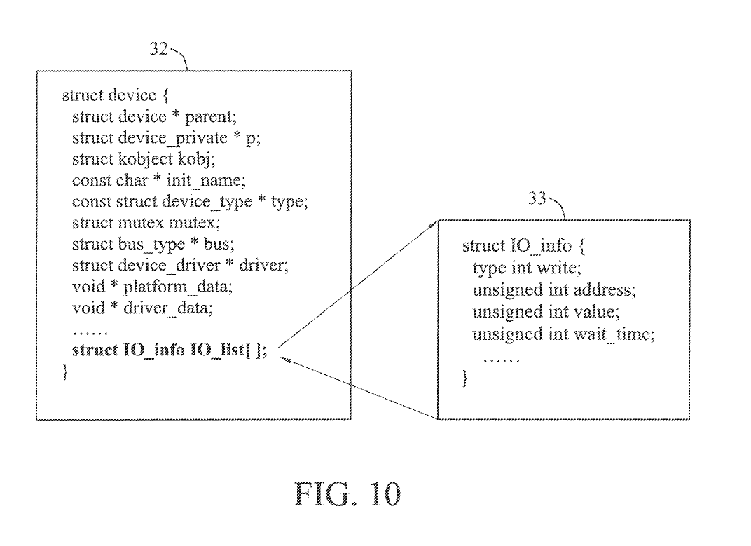

FIG. 10 is a schematic diagram of program codes of a data structure of an embodiment according to the present disclosure. The program codes of the data structure are program codes 32 of a data structure of a device in Linux. In an embodiment according to the present disclosure, “program codes 32 of a data structure used for storing the serialized hardware register settings (serialized hardware instructions)” can be installed in the program codes 32 of a data structure of a device.

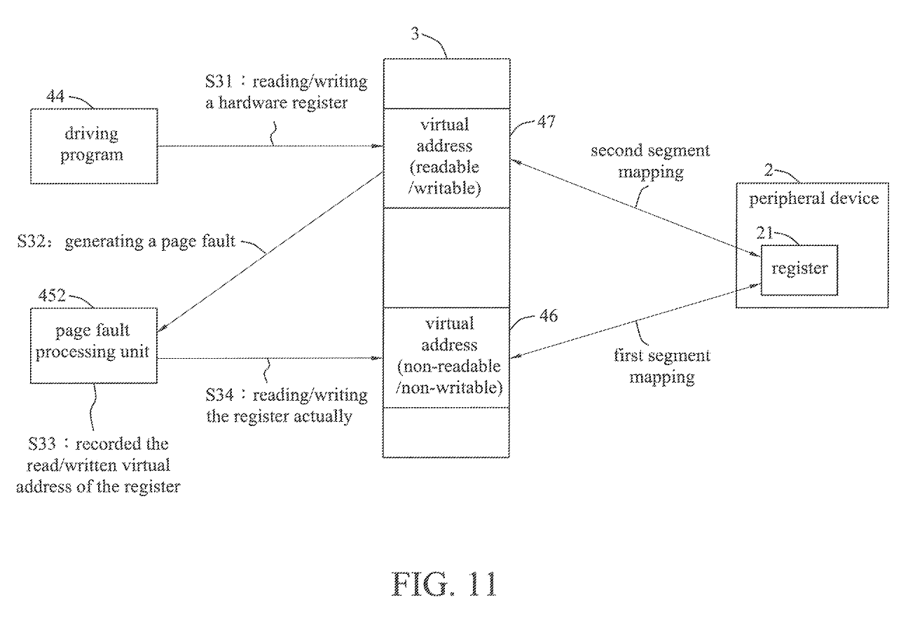

FIG. 11 is a schematic diagram illustrating monitoring a register 21 of a peripheral device 2 through a page fault processing mechanism to capture hardware register settings (hardware instructions) of an embodiment according to the present disclosure. As shown in the embodiment of FIG. 11 and FIG. 3, the instruction capturing module 42 can be monitoring program codes of software, and monitor the one or more registers 21 through the page fault processing mechanism to capture a plurality of hardware register settings (hardware instructions).

As shown in FIG. 11 and FIG. 3, when the one or more driving programs 44 initialize the one or more peripheral devices 2 to perform first segment mapping and second segment mapping of the memory 3 for the one or more registers 21, the memory 3 provides a readable/writable virtual address (a first page 46) and a non-readable/non-writable virtual address (a second page 47), and a mapping table 451 having the first page 46 and the second page 47.

When the one or more driving programs 44 reads/writes the one or more registers 21 with the virtual address of the second page 47 (step S31), a page fault is generated since the virtual address of the second page 47 is non-readable/non-writable, and a page fault processing unit 452 (step S32) is entered. The page fault processing unit 452 records readable/writable physical address and data of the one or more registers 21 into the data storing module 41 (step S33), and the driving program 44 reads/writes the one or more registers 21 through the virtual address of the first page 46 actually (step S34). The instruction capturing module 42 monitors reading/writing behaviors among the one or more driving programs 44, the memory 3, the register 21 and the page fault processing unit 452, so as to capture a plurality of hardware register settings (hardware instructions), wherein the reading/writing behaviors can be setting behaviors, input/output (I/O) behaviors or access behaviors.

As shown in FIG. 3, the electronic device 1 further comprises a system bus (see a bus 5). The instruction capturing module 42′ may be a bus monitor of hardware, and monitor the access behaviors of the one or more registers 21 through the system bus, so as to capture the plurality of hardware register settings (hardware instructions). In an embodiment, the bus 5 represents a system bus or a sub-bus.

As shown in FIG. 3, the electronic device 1 may further comprise a sub-bus (see the bus 5). The instruction capturing module 42 may be monitoring program codes of software, and monitor the one or more registers 21 through a data transmission interface of the sub-bus, so as to capture the plurality of hardware register settings (hardware instructions), wherein the data transmission interface is a PCI interface, a USB interface or other interfaces.

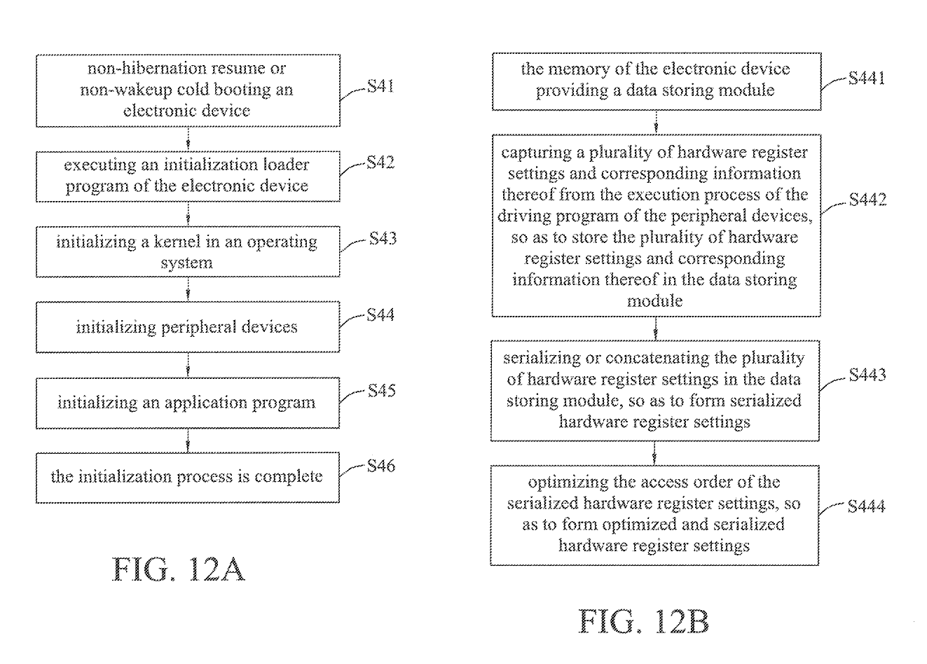

FIG. 12A is a flow chart illustrating that an electronic device 1 having a hibernation or wakeup booting function is performing a non-hibernation resume or non-wakeup cold boot of an embodiment according to the present disclosure. FIG. 12B is a flow chart illustrating a method for initializing a peripheral device 2 in step S44 of FIG. 12A of an embodiment according to the present disclosure.

As shown in the embodiment of FIG. 12A and FIG. 3, in step S41 the electronic device 1 is performing a cold boot for the first time. In step S42, an initialization loader program (boot-loader) of the electronic device 1 is executed. In step S43, a kernel 40 in an operating system 4 is initialized. In step S44, one or more peripheral devices 2 of the electronic device 1 are initialized. As shown in the embodiment of FIG. 12B and FIG. 3, step S441 to step S444 execute a method for initializing one or more peripheral devices 2 of an embodiment according to the present disclosure.

In an embodiment, in step S441, the memory 3 of the electronic device 13 provides or creates a data storing module 41, such as a data structure (a tree structure, a concatenated structure) or an array (an instruction array). In step S442, a plurality of hardware register settings (hardware instructions 441) and corresponding information thereof (e.g., the execution time or the instruction intervals for the hardware instructions) are captured from the driver execution process of the driving programs 44 of the one or more peripheral devices 2, so as to store the plurality of hardware register settings (hardware instructions 441) and corresponding information thereof in the data storing module 41. In step S443, the plurality of hardware register settings (hardware instructions 441) in the data storing module 41 are serialized or concatenated, so as to form serialized hardware register settings (serialized hardware instructions).

Step S444 can be executed or not to be executed optionally. In step S444, the access order of the serialized hardware register settings (serialized hardware instructions) is optimized, so as to form optimized and serialized hardware register settings (optimized and serialized hardware instructions).

The method for initializing one or more peripheral devices 2 according to the present disclosure has been described in details in FIGS. 3-11, further description thereof hereby omitted.

As shown in FIG. 12A and FIG. 3, in step S45 an application program is initialized. In step S46, the initialization process is complete.

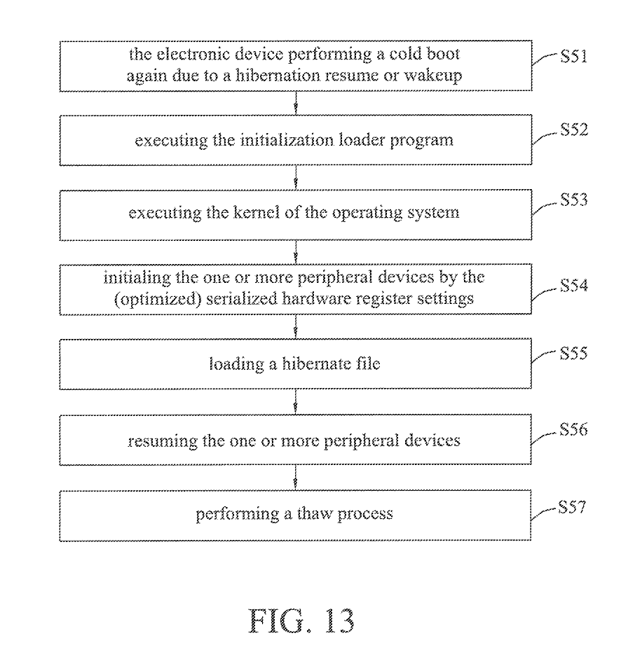

FIG. 13 is a flow chart illustrating that an electronic device 1 having a hibernation or wakeup booting function is performing a cold boot again due to hibernation resume or wakeup of an embodiment according to the present disclosure. As shown in FIG. 13 and FIG. 3, in step S51 the electronic device 1 is performing a cold boot again due to hibernation resume or wake. In step S52, the initialization loader program (boot-loader) is executed. In step S53, the kernel 40 of the operating system 4 is executed.

In step S54, the one or more peripheral devices 2 are initialized by the serialized hardware register settings (serialized hardware instructions), or the optimized and serialized hardware register settings (optimized and serialized hardware instructions). In step S55, a hibernate file is loaded. In step S56, the one or more peripheral devices 2 are resumed. In step S57, a thaw process (e.g., wakeup process) of the electronic device 1 is performed.

It is known from the above description that in a method for initializing a peripheral device and an electronic device using the method according to the present disclosure, when the electronic device is performing a non-hibernation resume or non-wakeup cold boot for the first time to initialize one or more peripheral devices, a plurality of hardware register settings (hardware instructions) are captured from a driver execution process of one or more peripheral devices and stored in a data storing module (e.g., a tree structure), and a plurality of hardware register settings are serialized or concatenated to form serialized hardware register settings (serialized hardware instructions). Besides, the serialized hardware register settings (serialized hardware instructions) can be further optimized to form optimized and serialized hardware instructions.

Therefore, in a method for initializing a peripheral device and an electronic device using the method according to the present disclosure the initialization process of the one or more peripheral devices is simplified, and only the serialized hardware register settings (serialized hardware instructions) or the optimized and serialized hardware register settings (optimized and serialized hardware instructions) are executing to initialize the one or more peripheral devices when the electronic device is performing a hibernation resume or wakeup cold boot again. Therefore, the initialization time for the one or more peripheral devices and the booting time for the electronic device are reduced.

To those skilled in the art that various modifications and variations can be made to the disclosed embodiments without departure the principle of the disclosure. It is intended that the specification and examples be considered as exemplary only, with a true scope of the disclosure being indicated by the following claims and their equivalents.

What is claimed is:

1. An electronic device, comprising:
one or more peripheral devices each having one or more registers;
a memory having a data storing module; and
an instruction capturing module configured to capture a plurality of hardware register settings from a driver execution process of the one or more peripheral devices, store the plurality of hardware register settings in the data storing module, and serialize or concatenate the plurality of hardware register settings in the data storing module to form serialized hardware register settings, when the electronic device is performing a non-hibernation resume or non-wakeup cold boot to execute an initialization process of the one or more peripheral devices,
wherein the one or more peripheral devices are configured to be initialized by the serialized hardware register settings, when the electronic device is performing cold boot again due to a hibernation resume or wakeup to execute the initialization process of the one or more peripheral devices.

2. The electronic device of claim 1, wherein the data storing module is a data structure or an array.

3. The electronic device of claim 1, wherein the plurality of hardware register settings are a plurality of hardware instructions.

4. The electronic device of claim 1, wherein the serialized hardware register settings are serialized hardware instructions.

5. The electronic device of claim 1, wherein the data storing module has one or more nodes representing the one or more peripheral devices, respectively, and wherein a relation of the nodes represents dependency of the peripheral devices, when there are a plurality of peripheral devices.

6. The electronic device of claim 5, wherein the one or more nodes each have one or more buffers storing the plurality of hardware register settings and execution time of the plurality of hardware register settings.

7. The electronic device of claim 1, wherein the instruction capturing module is monitoring program codes of software, and is configured to monitor the one or more registers in a page fault processing mechanism to capture the plurality of hardware register settings.

8. The electronic device of claim 1, further comprising a sub-bus, wherein the instruction capturing module is monitoring program codes of software, and is configured to monitor the one or more registers through a data transmission interface of the sub-bus to capture the plurality of hardware register settings.

9. The electronic device of claim 1, further comprising a system bus, wherein the instruction capturing module is a bus monitor of hardware, and is configured to monitor an access behavior of the one or more registers through the system bus to capture the plurality of hardware register settings.

10. The electronic device of claim 1, further comprising an optimization serialization module optimizing an access order of the serialized hardware register settings according to an optimization algorithm to form optimized and serialized hardware register settings.

11. The electronic device of claim 10, wherein the one or more peripheral devices are configured to be initialized by the optimized and serialized hardware register settings, when the electronic device is performing cold boot again due to the hibernation resume or wakeup to execute the initialization process of the one or more peripheral devices.

12. A method, comprising:
providing an electronic device having a hibernation or wakeup booting function, wherein the electronic device comprises one or more peripheral devices and a memory, the one or more peripheral devices each having one or more registers, and the memory having a data storing module;
capturing a plurality of hardware register settings from a driver execution process of the one or more peripheral devices, storing the plurality of hardware register settings in the data storing module, and serializing or concatenating the plurality of hardware register settings in the data storing module to form serialized hardware register settings, when the electronic device is performing a non-hibernation resume or non-wakeup cold boot to execute an initialization process of the one or more peripheral devices; and
initializing the one or more peripheral devices by the serialized hardware register settings, when the electronic device is performing cold boot again due to a hibernation resume or wakeup to execute the initialization process of the one or more peripheral devices.

13. The method of claim 12, wherein the data storing module is a data structure or an array, the plurality of hardware register settings are a plurality of hardware instructions, and the serialized hardware register settings are serialized hardware instructions.

14. The method of claim 12, wherein the data storing module has one or more nodes representing the one or more peripheral devices, respectively, and a relation of the nodes represents dependency of the peripheral devices, when there are a plurality of peripheral devices.

15. The method of claim 14, wherein the one or more nodes each have one or more buffers storing the plurality of hardware register settings and execution time of the plurality of hardware register settings.

16. The method of claim 12, further comprising enabling monitoring program codes of software to monitor the one or more registers through a page fault processing mechanism to capture the plurality of hardware register settings.

17. The method of claim 12, further comprising enabling monitoring program codes of software to monitor the one or more registers through a data transmission interface of a sub-bus of the electronic device to capture the plurality of hardware register settings.

18. The method of claim 12, further comprising enabling a bus monitor of hardware to monitor an access behavior of the one or more registers through a system bus of the electronic device to capture the plurality of hardware register settings.

19. The method of claim 12, further comprising optimizing an access order of the serialized hardware register settings according to an optimization algorithm to form optimized and serialized hardware register settings.

20. The method of claim 19, further comprising initializing the one or more peripheral devices by the optimized and serialized hardware register settings, when the electronic device is performing cold boot again due to the hibernation resume or wakeup to execute the initialization process of the one or more peripheral devices.
